(19) United States
(12) Patent Application Publication
(10) Pub. No.: US 2003/0171120 A1
(43) Pub. Date: Sep. 11, 2003

(54) Method of setting up a call connection, a method of preventing or alleviating denial of service attacks, a ratio telecommunications network, and a base station

(76) Inventor: Mazlyn Mona Mustapha, Swindon (GB)

Correspondence Address: Lucent Technologies Inc., Docket Administrator (Room 3J-219), 101 Crawfords Corner Road, Holmdel, NJ, 07733-3030, US

(21) Appl. No.: 10/379,347

(22) Filed: Mar. 4, 2003

(30) Foreign Application Priority Data
Mar. 6, 2002 (GB) 0205286.8

(51) Int. Cl. H04Q 7/20

(52) U.S. Cl. 455/445; 455/401

(57) ABSTRACT

A method of setting up a call connection between a base station and a user terminal of a radio telecommunications network. The base station, upon receipt of a first call setup request from the user terminal, ignores any subsequently received call setup requests from the user terminal that are received during a predetermined period.

### CROSS REFERENCE TO RELATED APPLICATION

This application claims priority of European Application No. 0205286.8 filed on Mar. 6, 2002.

### FIELD OF THE INVENTION

The present invention relates to a method of controlling denial of service attacks.

### BACKGROUND OF THE INVENTION

Initial access on a UMTS network is obtained by a mobile user terminal sending a request for service on the Random Access Channel (RACH). For the mobile, a timer (T300) is defined in the Third Generation Partnership Project 3GPP specifications (that define the standards to which any Universal Mobile Telecommunications System UMTS must adhere). This timer T300 allows the mobile to attempt a second (or subsequent) request for service when the timer expires and there is no response from the network. Any number of service requests from the same mobile will be processed, thus using up precious network resources. This weakness may be exploited by anyone attempting a ‘denial-of-service’ attack by sending many initial access attempts from the same mobile. The network would then be overloaded by the large number of attempts, and thus service would be disrupted for genuine users.

A ‘denial-of-service’ attack is an attempt to overload a system (or part of a system), in order to make the service provided by the system unavailable to legitimate users. For example, a ‘denial-of-service’ attack on an Internet service provider by overloading access to their system would result in users not being able to access the Internet. Such attacks cost system operators loss of revenue due to legitimate users not being able to obtain services. Furthermore, this type of attack tarnishes the image of the system operator in the eyes of users because the user was not able to obtain access to the services provided by the system, in other words he receives poor service.

For a user to obtain access to a UMTS network, the user sends an initial access request to the network on the Random Access Channel (RACH) on the air interface. The network then proceeds to allocate resources to the user (e.g. channelization codes, power, bandwidth, etc) and sends an acknowledgement to the user to say that the resources have been allocated. The user will then continue with the normal service.

As shown in FIG. 1, in a known approach, as defined in 3GPP specifications namely Technical Specification 25.331, a timer T300 is used in the mobile, which is initialised when the user first sends an initial access request to the network. If the user receives an acknowledgement from the network, the timer is stopped. However, if no response is received from the network by the time the timer expires (perhaps due to some error caused in transmitting the first initial access request or some error in network acknowledgement on the air interface), the user may attempt a second initial access request after a ‘persistency’ time.

As shown in FIG. 2, in the known system if a ‘denial-of-service’ attack is attempted on the UMTS air interface where multiple initial access requests from the same mobile user terminal are sent to the network in quick succession (less than the T300 period), the network will continue to allocate resources to that same user terminal. If this is allowed to continue, the network resources are quickly exhausted resulting in user terminals of other legitimate users being unable to obtain access to the network.

### SUMMARY OF THE INVENTION

The present invention provides a method of setting up a call connection between a base station and a user terminal of a radio telecommunications network in which the base station upon receipt of a first call setup request from the user terminal ignores any subsequently received call setup requests from the user terminal that are received during a predetermined period.

Advantageously, the base station may respond to the first call setup request by sending a response message to the user terminal.

Advantageously, the network may be at least substantially in accordance with Universal Mobile Telecommunications System standards. Advantageously, the base station comprises a Node B antenna station and a radio network controller RNC. Advantageously, each call setup request may be made on a Random Access Channel RACH Advantageously, the period may be at least substantially equal in length to about the T300 period defined for the user terminal in UMTS standards.

The present invention also provides a corresponding method of preventing or alleviating denial of service attacks on a base station of a telecommunications network, a corresponding radio telecommunications network, and a corresponding a radio telecommunications base station.

The present invention also provides a method of preventing or alleviating denial of service attacks on a base station of a telecommunications network including a user terminal by the base station upon receipt of first call setup request from the user terminal ignoring any subsequently received call setup requests from the user terminal that are received during a predetermined period.

The present invention also provides a radio telecommunications network comprising a base station and a user terminal, operative such that upon receipt of a first call setup from the user terminal, the base station ignores any subsequently received call setup requests from the user terminal that are received during a predetermined period.

The present invention also provides a radio telecommunications base station operative such that upon receipt of an initial call setup from a user terminal, the base station sends a response and ignores any subsequently received call setup requests from the user terminal that are received during a predetermined period.

### BRIEF DESCRIPTION OF THE DRAWINGS

The present invention will be better understood from reading the following description of non-limiting embodiments, with reference to the attached drawings, wherein below:

FIG. 1 is a diagram illustrating an exemplary known message sequence in call setup;

FIG. 2 is a diagram illustrating a known message sequence during a denial of service attack;

FIG. 3 is a diagram illustrating a UMTS network including a UMTS terrestrial radio access network UTRAN and a mobile user terminal (user equipment UE);

FIG. 4 is a diagram illustrating an example message sequence in call setup in an embodiment of the invention; and

FIG. 5 is a diagram illustrating a message sequence during a denial of service attack in an embodiment of the invention.

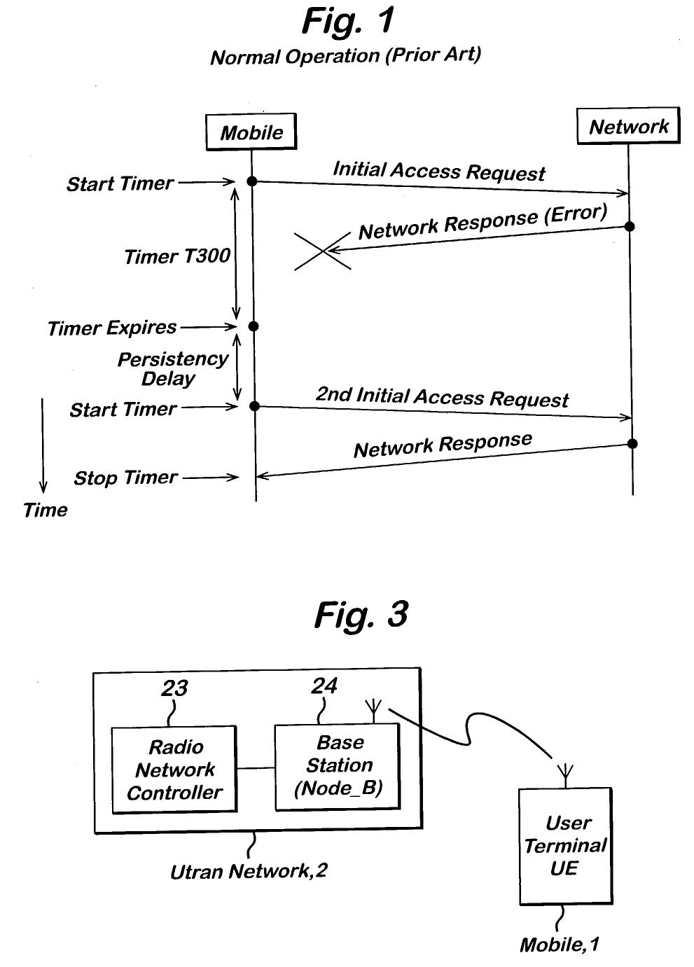

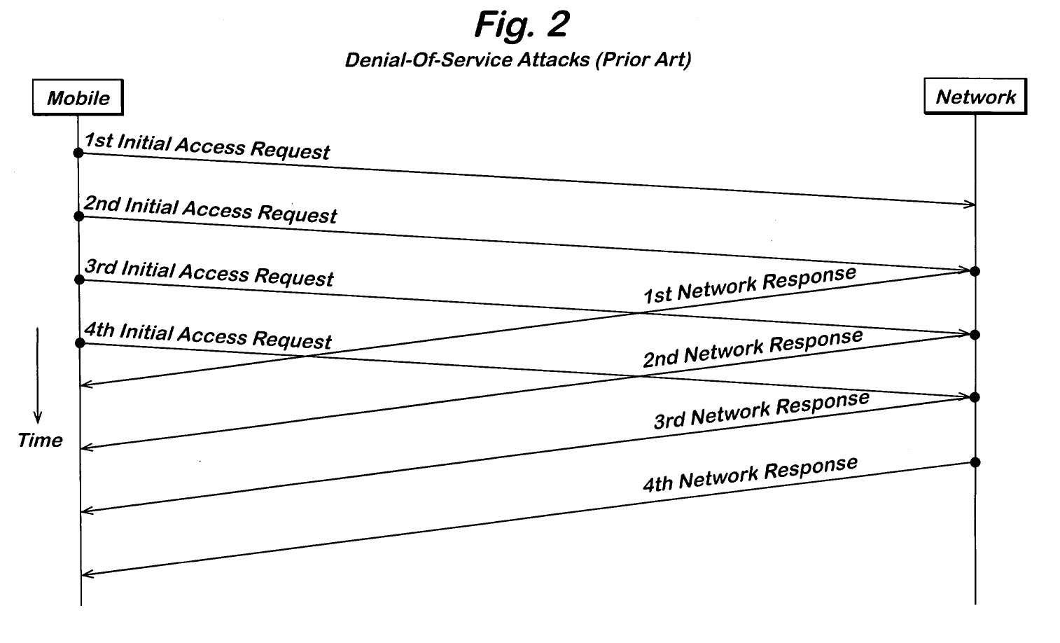

It should be emphasized that the drawings of the instant application are not to scale but are merely representations of the invention, which may be determined by one of skill in the art by examination of the information contained herein.

### DETAILED DESCRIPTION

The present invention relates to setting up a call connection between a base station and a user terminal of a radio telecommunications network. The present invention also relates to a method of preventing or alleviating denial of service attacks on a base station of a telecommunications network. The present invention also relates to a radio telecommunications network comprising a base station and a user terminal. The present invention also relates to a radio telecommunications base station.

In known systems, there may be no timers at the network similar to the to the timer T300 defined in Technical Specification TS 25.331 for user terminals. The invention in its embodiments provides a way of reducing the chances of ‘denial-of-service’ attacks on the air interface of a UMTS network, in particular by reducing “denial of service” attacks via the Random Access Channel. This problem may be alleviated by having a timer implemented in the network, where any initial access originating from the same mobile which arrives before the expiry of the timer is discarded. The timer is used at the network to distinguish between legitimate re-tries of the initial access request and ‘denial-of-service’ attacks.

As shown in FIG. 3, a preferred UMTS radio access network UTRAN 2 consists of a radio network controller RNC 23 which controls the operation of several base stations 24 (denoted NodeB in UMTS terminology) (one of which is shown in FIG. 3 for simplicity). A base station 24 communicates with a mobile user terminal 1 (user equipment UE) during a call connection to that user terminal UE.

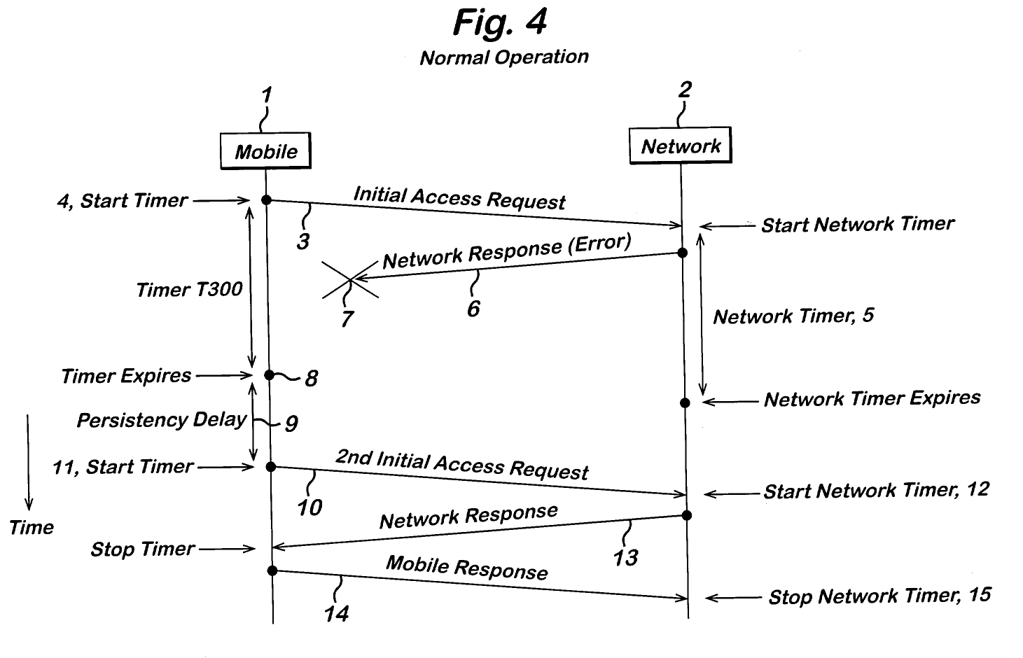

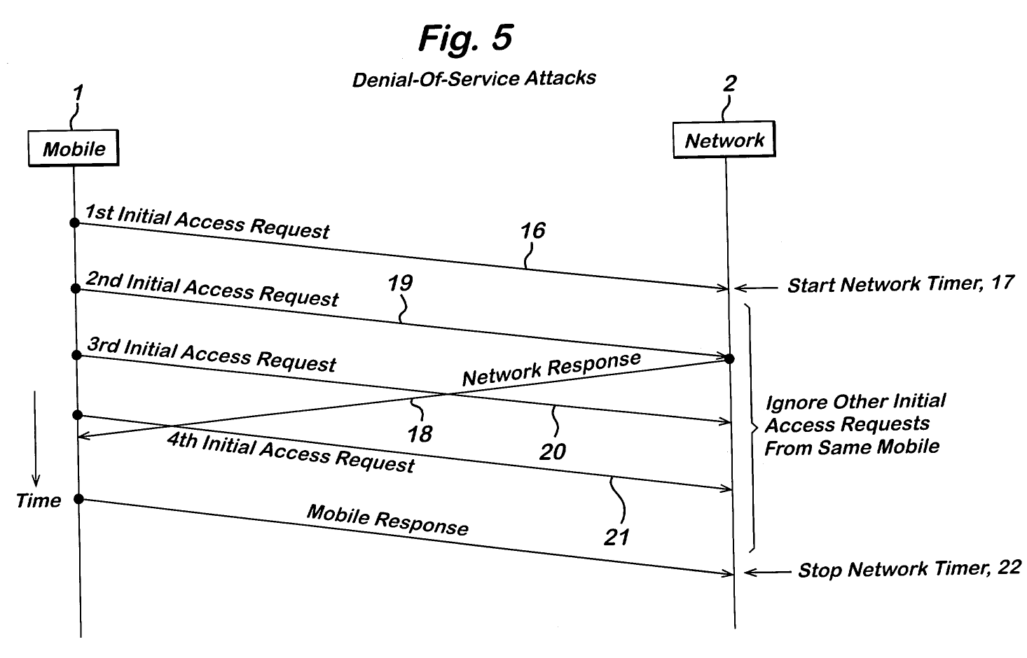

A timer that is identical to T300 timer for the mobile user terminal UE is implemented at the network UTRAN 2. As shown in FIGS. 4 and 5, this timer, called a network timer, starts timing when a first initial access request is received from a particular mobile user terminal. By using this timer, the network is able to distinguish whether a second initial access attempt is legitimate (the network timer period having expired as shown in FIG. 4) or not (network timer having not expired as shown in FIG. 5). As shown in FIG. 5, any duplicate initial access attempt for connection to the same mobile user terminal will be discarded if the network timer has not expired, as occurs when under a denial-of-service attack.

As shown in FIG. 4, a possible example sequence in normal operation as follows:

a. The mobile user terminal 1 sends an initial access request 3 to the UTRAN network 2, and starts its T300 timer 4,

b. The network 2 starts its network timer to time a predetermined period 5 on receipt of the initial access request 3 then sends a response 6 (network response),

c. The network timer in due course stops after the predetermined timed period has passed,

d. Say this response is not received correctly 7 by the mobile 1, after the timer T300 has timed out 8 the T300 period and an extra delay (persistancy delay 9) has also passed, the mobile 1 sends a second access request 10 and restarts its T300 timer 11,

e. Receipt of the second access request causes the network 2 to restart 12 its timer and send a response (network response 13),

f. The mobile then responds 14 as a next step in setting up the connection,

g. In due course the network timer finishes 15 its timing.

As shown in FIG. 5 an example sequence in a Denial of Service attack is as follows:

a. The mobile 1 sends an initial access request 16 to the network 2,

b. On receipt of the initial access request 16, the network 2 starts 17 its network timer and sends a network response 18 to the mobile 2,

c. Multiple subsequent access requests 19, 20,21 are received in rapid succession from the mobile 1. These subsequent access requests are ignored by the network 2 as they are received before the network timer has finished 22 timing out the predetermined time period.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. A method of setting up a call connection from at least one user terminal of a radio telecommunications network in which upon receipt of a first call setup request from the user terminal ignores subsequently received call setup requests from the user terminal received during a predetermined period.

2. A method according to claim 1, wherein the base station responds to the first call setup request by sending a response message to the user terminal.

3. A method according to claim 1, wherein the network is at least substantially in accordance with Universal Mobile Telecommunications System standards.

4. A method according to claim 3, wherein the base station comprises a Node B antenna station and a radio network controller RNC.

5. A method according to claim 3, wherein each call setup request is made on a Random Access Channel RACH.

6. A method according to claim 1, wherein the period is at least substantially equal in length to the T300 period defined for the user terminal in UMTS standards.

7. A method of preventing or alleviating denial of service attacks on a base station of a telecommunications network including a user terminal by the base station upon receipt of first call setup request from the user terminal ignoring any subsequently received call setup requests from the user terminal that are received during a predetermined period.

8. A radio telecommunications network comprising a base station and a user terminal, operative such that upon receipt of a first call setup from the user terminal, the base station ignores any subsequently received call setup requests from the user terminal received during a predetermined period.

9. A radio telecommunications base station operative such that upon receipt of an initial call setup from a user terminal, the base station sends a response and ignores any subsequently received call setup requests from the user terminal that are received during a predetermined period.

10. A method of setting up a call connection from a base station of a radio telecommunications network in which upon receipt of a first call setup request ignores subsequently received call setup requests received during a predetermined period.
